(19) United States
(12) Patent Application Publication
(10) Pub. No.: US 2022/0245656 A1
(43) Pub. Date: Aug. 4, 2022

(54) METHODS AND SYSTEMS FOR DELIVERING INTERACTIVE DATA UNITS

(71) Applicant: Ibotta, Inc., Denver, CO (US)

(72) Inventors: Bryan LEACH, Denver, CO (US); Luke SWANSON, Denver, CO (US)

(21) Appl. No.: 17/709,097

(22) Filed: Mar. 30, 2022

Related U.S. Application Data
(60) Provisional application No. 63/170,044, filed on Apr. 2, 2021.

(51) Int. Cl. G06Q 30/02

(52) U.S. Cl. CPC G06Q 30/0201; G06Q 30/0234

(57) ABSTRACT

The computer networks provided herein facilitate the delivery of interactive data units to client nodes. In some instance, the computer networks may facilitate the delivery of interactive data units to a subset of the client nodes.

### CROSS-REFERENCE

This application claims priority to U.S. Provisional Patent Application No. 63/170,444 filed on Apr. 2, 2021, which application is incorporated herein by reference in its entirety for all purposes.

### BACKGROUND

A computer network may facilitate the exchange, and/or delivery, of data packets between a server and a client node, or between multiple client nodes, to distribute data packets to users. For example, each client node may be associated with a user. In some instances, the distribution of data packets from the server to a client node may be based at least in part on information associated with data packets and/or the client node.

### SUMMARY

Recognized herein is a need for computer networks for delivering data communications (e.g., interactive data units) to client nodes. A client node may be associated with, and/or be accessible by, a user. Data communications may be delivered via multiple channels to the user. The communications may be a general broadcast directed to the general public or a group or a sub-group that the user is a member of. In other instances, the communication may be directed specially to the user. In some instances, the communication may even be tailored or customized for the user. Beneficially, the data communications providers, i.e., the interactive data units providers, may have some interest in having the interactive data units to be delivered to a specific group of users for strategic reasons. In some instances, a computer network may facilitate delivery for interactive data units, based on the criteria associated with the interactive data units, to client nodes.

In an aspect, provided herein is a computer-implemented method for providing real-time interactive units in a user experience, comprising retrieving, by one or more computer processors, transaction data associated with a potential transaction of a user; selecting, by one or more computer processors, one or more interactive data units from a plurality of interactive data units based at least in part on (i) the respective criteria associated with each interactive data unit of the plurality of interactive data units, and (ii) the transaction data associated with the potential transaction; presenting the one or more interactive data units to the user via a user device of the user; detecting, by one or more computer processors, a completion of the potential transaction via one of the one or more interactive data units; and altering an account of the user based on information associated with the one of the one or more interactive data unit via which the transaction was completed.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a block diagram depicting an example system, according to embodiments of the present disclosure, comprising a client-server architecture and network configured to perform the various methods described herein.

FIG. 2 is a flow diagram depicting an example process for delivering interactive data units, according to one exemplary embodiment.

FIG. 3 illustrates an example user interface provided on a client node.

FIG. 4 illustrates an example user interface provided on a client node.

FIG. 5 illustrates an example user interface provided on a client node.

FIG. 6 illustrates an example user interface provided on a client node.

FIG. 7 illustrates an example user interface provided on a client node.

FIG. 8 illustrates an example user interface provided on a client node.

FIG. 9 illustrates an example user interface provided on a client node.

FIG. 10 is a flow diagram depicting an example process for delivering interactive data units, according to one exemplary embodiment.

FIG. 11 is a block diagram depicting an example system for delivering interactive data units, according to one exemplary embodiment

FIG. 12 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

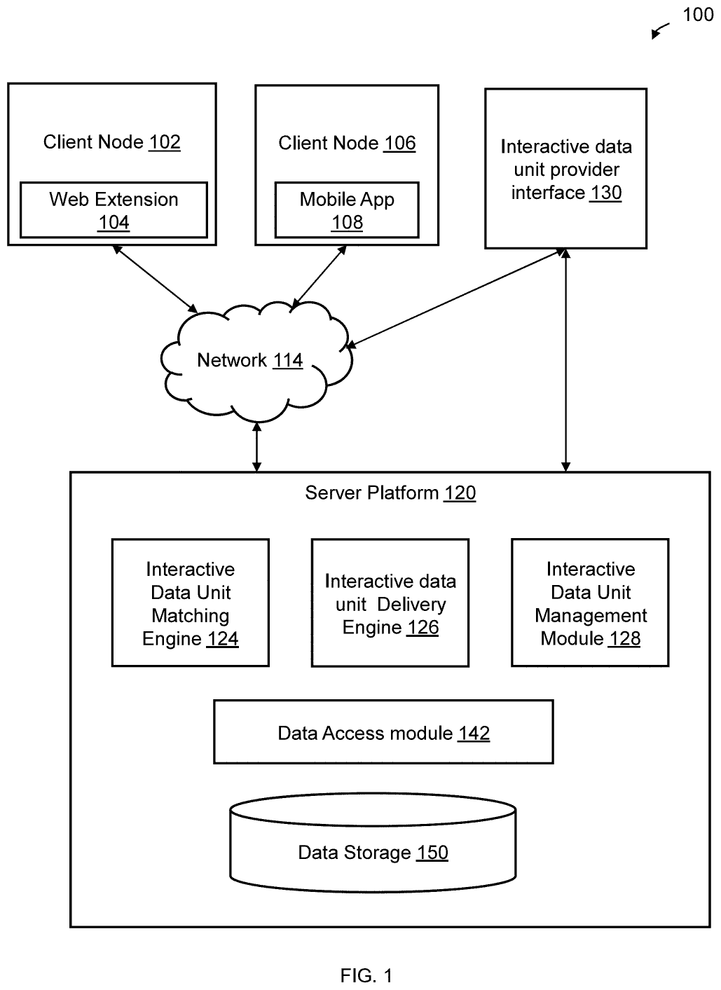

FIG. 1 is a block diagram depicting an example system 100 comprising a client-server architecture and network configured to perform the various methods described herein. A platform (e.g., machines and software, possibly interoperating via a series of network connections, protocols, application-level interfaces, and so on), in the form of a server platform 120, provides server-side functionality via a communication network 114 (e.g., the Internet or other types of wide-area networks (WANs), such as wireless networks or private networks with additional security appropriate to tasks performed by a user) to one or more client nodes 102, 106, and/or one or more interactive data unit provider interfaces (e.g., interactive data unit provider interface 130). FIG. 1 illustrates, for example, a client node 102 hosting a web extension 104, thus allowing a user to access functions provided by the server platform 120, for example, receiving an interactive data unit from the server platform 120. The web extension 104 may be compatible with any web browser application used by a user of the client node. Further, FIG. 1 illustrates, for example, another client node 106 hosting a mobile application 108, thus allowing a user to access functions provide by the server platform 120, for example, receiving an interactive data unit from the server platform 120. Delivery may be through a wired or wireless mode of communication. The interactive data unit may include, without limitation, data content in a format that is intended to solicit user response or a format that is intended to elicit user activity or response. Examples of interactive data unit include, without limitation, notifications, offers, and alerts. In some embodiments, the interactive data unit may comprise notification, offers, and/or alerts of rewards (e.g., cash rewards, credit rewards, etc.) that will transfer to a user if the user makes a purchase via a particular payment method (e.g., credit card issued by Bank A, payment plans facilitated by a financial institution or an entity, etc.). For example, the rewards may be a fixed amount of cash/credit rewards, or it can be a percentage of the transaction amount.

A client node (e.g., client node 102 and/or client node 106) may be, for example, a user device (e.g., mobile electronic device, stationary electronic device, etc.). A client node may be associated with, and/or be accessible to, a user. In another example, a client node may be a computing device (e.g., server) accessible to, and/or associated with, an individual or entity. A node may comprise a network module (e.g., network adaptor) configured to transmit and/or receive data. Via the nodes in the computer network, multiple users and/or servers may communicate and exchange data, such as interactive data units. In some instances, the client nodes may receive and present to a user an Internet-featured item (e.g., an image of a product, a virtual shopping cart, a payment method or multiple payment methods on a check-out web page). The client nodes may also gather data associated with a check-out page and transmit information associated with a potential purchase or transaction to the server platform 120 (e.g., transaction data). Examples of the transaction data associated with the potential purchase include, without limitation, web site URL, web site category (e.g., sport goods retailer, first aids retailer, grocery retailer, airline company, etc.), virtual cart item category (e.g., sport goods, first aids suppliers, groceries, airline ticket, concert ticket, etc.), virtual cart item amount, total potential transaction amount, user ID, and current known wallet associated with the user (e.g., payment methods comprising credit card information, fintech payment information, cryptocurrency payment/account information, or other payment-related information).

In at least some examples, the server platform 120 may be one or more computing devices or systems, storage devices, and other components that include, or facilitate the operation of, various execution modules depicted in FIG. 1. These modules may include, for example, interactive data unit matching engine 124, interactive data unit delivery engine 126, interactive data unit management module 128, data access modules 142, and data storage 150. Each of these modules is described in greater detail below.

The interactive data unit management module 128 may receive and manage interactive data units. The interactive data units, in some embodiments, may comprise a monetary incentive that is rewarded to a user if the user completes a transaction (e.g., purchase) via a select payment method. For example, an interactive data unity may comprise a notification or alert of “pay with your Visa card to earn a $2.00 cash reward.” In some embodiments, the interactive data unit management module 128 may receive parameters or criteria regarding one or more interactive data units devised by providers or creators of the interactive data units (e.g., financial institutions or other entities) for possible presentation to one or more users. In an example, such parameters may include user-demographic-based target criteria, transaction-based target criteria, or some other considerations associated with the interactive data units. The user-demographic-based target criteria may include a list of criteria associated with user data of the users, such as, without limitation, user age, gender, location, income, credit scores, debt defaults, device information, propensity of travelling (domestic and/or international), propensity of purchasing newest electronic devices, propensity of going to newly-opened restaurants, and the like. Some of the user information may be accessible by the providers of the interactive data units (e.g., banks) because of the nature of the business model of the providers. Some other ways of gaining these user-demographic-based target criteria include gathering data from a user-filled profile generated during registration or modified after registration, or gathered from the user or user's device with consent, by the providers of the interactive data units and/or by the server platform 120. This information helps the interactive data unit provider to target the cluster of users that may provide the optimal return on investment (ROI) with low cost of acquisition. Additionally, the information may also help the interactive data unit provider to make strategic targeting decisions when providing the incentives. For example, Bank A may want to attract more users who like to travel, and thus provide incentives to these users that, from user data, are identified as having a high propensity for travel; and Bank B may want to attract more users who like to go to concerts, and thus provide incentives to these users that, from user data, are identified as having a high propensity for attending concerts.

As described elsewhere herein, the interactive data units may also be associated with transaction-based target criteria. These criteria may include, without limitation, web page categories (e.g., sport goods retailer, first aids retailer, grocery retailer, airline company, etc.), virtual cart item category (e.g., sport goods, first aids suppliers, groceries, airline ticket, concert ticket, etc.), a range of virtual cart item amount, a range of total potential transaction amount, date and/or time range of the transaction, a reward (incentive) range for the transaction, and the like. These criteria may help the interactive data units providers (e.g., financial institutions) target the subset of users they want to incentivize to make purchases via the payment methods they provide.

As described elsewhere herein, the interactive data units may be associated with user-demographic-based target criteria, transaction-based target criteria, or a combination thereof. In one example, the criteria associated with a particular interactive data unit (e.g., incentive for using Bank A's credit card) may be structured as below: a female in age range 30-40, who lives in Denver, Colo., with a potential purchase amount of above 500 dollars. In this example, the criteria regarding gender, age, geographic location (i.e., user-demographic-based target criteria) are combined with criteria regarding the potential purchase amount (i.e., transaction-based target criteria) to provide the optimal target parameters of a particular interactive data unit and allow the provider (issuer) to customize targeting structure for the interactive data unit. In another example, the criteria associated with another particular interactive data unit may be structured as below: a male in age range 40-60, who is about to make a purchase on sports goods, with a propensity of skiing every snow season. Similarly to the above example, the user-demographic-based target criteria are combined with transaction-based target criteria to provide optimal outcome for both the users and the providers.

The interactive data unit matching engine 124 may match the interactive data units defined or generated by various providers (e.g., manufacturers, merchants, retailers, or other entities) as set forth by the parameters defining the interactive data units. In some embodiments, the interactive data unit matching engine 124 of the server platform 120 may receive information associated with a potential purchase or transaction from the client node 102, as described elsewhere herein. For example, the client nodes may detect that the user is viewing a check-out web page associated with a retailer's web page. The client nodes may then operate alone or in connection with the interactive data unit matching engine 124 to retrieve transaction data associated with the potential transaction. The transaction data may include, as described elsewhere herein, web site URL, web site category (e.g., sport goods retailer, first aids retailer, grocery retailer, airline company, etc.), virtual cart item category (e.g., sport goods, first aids suppliers, groceries, airline ticket, concert ticket, etc.), virtual cart item amount, total potential transaction amount, user ID, current known wallet associated with the user (e.g., payment methods comprising credit card information, fintech payment information, cryptocurrency payment/account information, or other payment-related information), etc. The transaction data may comprise user data of the user. Alternatively, user data may be provided independently of the transaction data. The client nodes may transmit the transaction data and/or user data to one or more components of the server platform 120 (e.g., interactive data unit matching engine 124, interactive data unit management module 128, etc.), or the one or more components of the server platform 120 may actively fetch the transaction data and/or user data from the client nodes.

Once the transaction data associated with the potential transaction is received, the interactive data unit matching engine 124 may query the interactive data unit management module 128 to identify and/or select one or more interactive data units (e.g., rewards or incentives) that matches the transaction data. The targeting criteria associated with the interactive data units, as described elsewhere herein, are taken into consideration by one or more matching algorithms to identify one or more interactive data units that match the potential transaction. In some embodiments, the one or more matching algorithms may identify one interactive data unit matching the potential transaction. In other embodiments, the marching algorithms may identify multiple interactive data units matching the potential transaction. For example, a potential transaction associated with transaction data comprising a female who is in her 30s purchasing a tent may match with both (1) an interactive data unit comprising a cash reward A from Bank A for a first activity (e.g., pay using card A from Bank A) and (2) an interactive data unit comprising credit reward B from Bank B for a second activity (e.g., pay using card B from Bank B). In this scenario, both matched interactive data units can be presented to the user. The user may choose between which one of the activities presented by the two interactive data units to perform for this transaction (e.g., purchase) based on the reward offered for each activity. The activity required by an interactive data unit may comprise an action that completes the transaction from the potential transaction. For example, the activity may comprise a purchase action, an ‘add item to cart’ action, an action to access, upload, or download certain content, etc. Alternatively, the one or more matching algorithms may choose one from the two matched interactive data units from the backend and present the chosen one to the user. In some other embodiments, the one or more matching algorithms may calculate a matching score based on the transaction data and the criteria associated with each available interactive data unit. The interactive data units with a matching score above a predetermined threshold may be considered as matched, and presented to the user. The interactive data unit providers may assign a weight to each criterion of the criteria associated with the interactive data units as needed. Multiple matching algorithms may be utilized by the interactive data unit matching engine 124 to identify the optimal interactive data units to present to the user, and it may be operated in real-time. As such, the user may be presented with all interactive data units found to match with the transaction data, a subset of interactive data units found to match with the transaction data (e.g., with matching scores above a predetermined threshold), or only one interactive data unit found to match with the transaction data (e.g., with the highest matching score).

The interactive data unit delivery engine 126 may operate to deliver the matched interactive data unit(s) to client nodes associated with users. This operation may be performed in real-time, i.e., as soon as the user is on the check-out page, the interactive data unit delivery engine 126 of the server platform 120 may deliver the matched interactive data unit(s) for presentation on or in coordination with the check-out page. This may require the server platform 120 to actively monitor and retrieve the relevant data (e.g., transaction data, targeting criteria, etc.), and perform the matching (or bidding) process by the server in real-time. The interactive data unit delivery engine 126 may retrieve (e.g., scrape) the check-out web page for fields indicating payment information or payment options, such as credit card fields. This retrieving operation may be performed actively by the interactive data unit delivery engine 126 in real-time. The interactive data unit delivery engine 126 may then deliver the matched interactive data units to the web page on client nodes. The interactive data units may be injected into the web page to facilitate an integrated user experience by altering the appearance (e.g., emphasizing) of one or more areas in the check-out web page with or based on the interactive data units. This user experience may be displayed in various manners, such as placing a colored box surrounding the credit card field with notes specifying the rewards provided by the interactive data unit. In other embodiments, other icons may be placed outside of the credit card field, or items that highlight the text in the check-out experience may be injected, or a box surrounding alternative payment options provided. While some examples of injecting the interactive data units into a user experience are provided, it will be appreciated that other forms of displaying/injecting interactive data units may be utilized to facilitate user experience.

Data access modules 142 may facilitate access to data storage 150 of the server platform 120 by any of the remaining modules 124, 126, and 128 of the server platform 120. In one example, one or more of the data access modules 142 may be database access modules, or may be any kind of data access module capable of storing data to, and/or retrieving data from, the data storage 150 according to the needs of the particular module 124, 126, and 128 employing the data access modules 142 to access the data storage 150. Examples of the data storage 150 include, but are not limited to, one or more data storage components, such as magnetic disk drives, optical disk drives, solid state disk (SSD) drives, and other forms of nonvolatile and volatile memory components.

As shown in FIG. 1, the interactive data unit provider interface 130 may be coupled directly to the server platform 120, thus circumventing the network 114. For example, the interactive data unit provider interface 130 may be co-located with the server platform 120, coupled thereto via a local network interface. As shown in FIG. 1, the interactive data unit provider interface 130 may also communicate with the server platform 120 via a private or public network system, such as the network 114. The interactive data unit provider interface 130 may allow interactive data unit providers (e.g., bidders) to access the functionalities of server platform 120.

At least some of the embodiments described herein with respect to the system 100 of FIG. 1 provide various techniques for generating, and delivering to client nodes, interactive data units which are activateable, or otherwise engageable, by user input, user activity, and/or user response. For example, the interactive data units may be activateable by user activity such as the purchase of products, services, and the like. The activation of an interactive data unit may output the delivery of a value to a client. For example, the value may be a credit (e.g., financial credit, rewards, points, value, etc.) transmitted to a user's account. In some instances, a user may receive, or redeem, the value by engaging the interactive data unit. An interactive data unit may be personalized or tailored to the customer receiving the interactive data unit at the selected client node (e.g., user device). In some embodiments, the system 100 of FIG. 1 provides various techniques for altering the appearance of a payment method if the payment method is identified to have matched with a potential payment associated with targeted users.

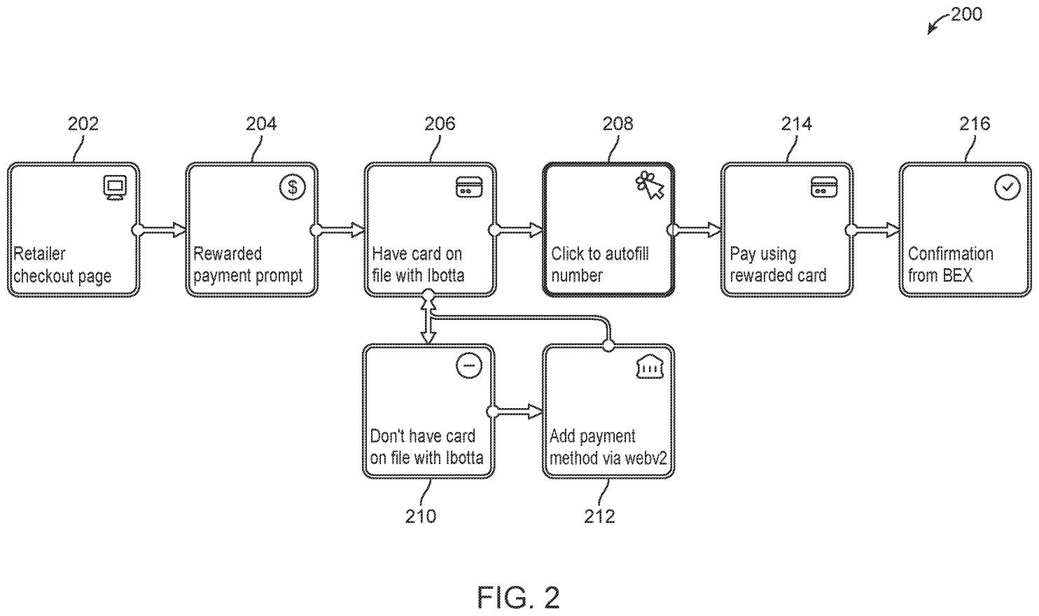

FIG. 2 is a flow diagram depicting an example process 200 for delivering interactive data units, according to one exemplary embodiment. The process may be performed by the system 100 of FIG. 1. As depicted in FIG. 2, once the platforms and systems of the present disclosure are initialized, the process 200 begins with operation 202, wherein the system 100 detects that one or more client nodes are presenting a retailer's check-out page to a user. In some embodiments, the client nodes 102 and 106 may collect transaction data associated with one or more potential transaction on the client nodes. In some cases, both the browser extension (BEX) 104 and the mobile application 108 may collect transaction data and communicate with the server platform 120. The process 200 may then proceed to operation 204, wherein the system 100 gathers the rewarded payment prompt. In some embodiments, operation 204 may be performed by the interactive data unit matching engine 124 to identify the rewarded payment prompt. In some cases, the above operations may be accomplished with a Java Script library that the website holder (e.g., retailer) can add directly to their web pages.

Next, the process 200 may proceed to operation 206, in which the system 100 may query the card(s) on file with server platform 120 associated with the user of the client node. In some embodiments, the system 100 query not only the card(s) on file with the platform 120, but all other alternative payment methods on file with server platform 120 as well. For example, the system 120 may query database 150 for payment methods on file associated with the user. If the system 100 determines that there is/are payment method(s) on file associated with the user, then the process 200 may proceed to operation 208, in which the user is presented with the option to autofill the payment information, such as credit card numbers, or alternative payment method account information with information already on file. If the system 100 determines there is no existing payment method on file associated with the user in operation 210, then the process 200 may proceed to request 212 the user to add a payment method (e.g., via Webv2). Next, the process 200 proceeds to operation 214, wherein the system 100 presents the user an interface that allows the user to complete the transaction using the rewarded payment method. Once the user completes the payment, the process 200 proceeds to operation 216, in which the system 100 receives a confirmation of completion of the transaction from the browser extension (BEX) 104 or the mobile application 108, depending on what type of interface the client node is accessing. In some cases, the process 200 may also operate with the same or substantially similar functionalities when the user shops in-store. For example, the user may shop in a store, and pay with mobile payment methods (e.g., digital wallets, fintech payments, Apple Pay®, etc.).

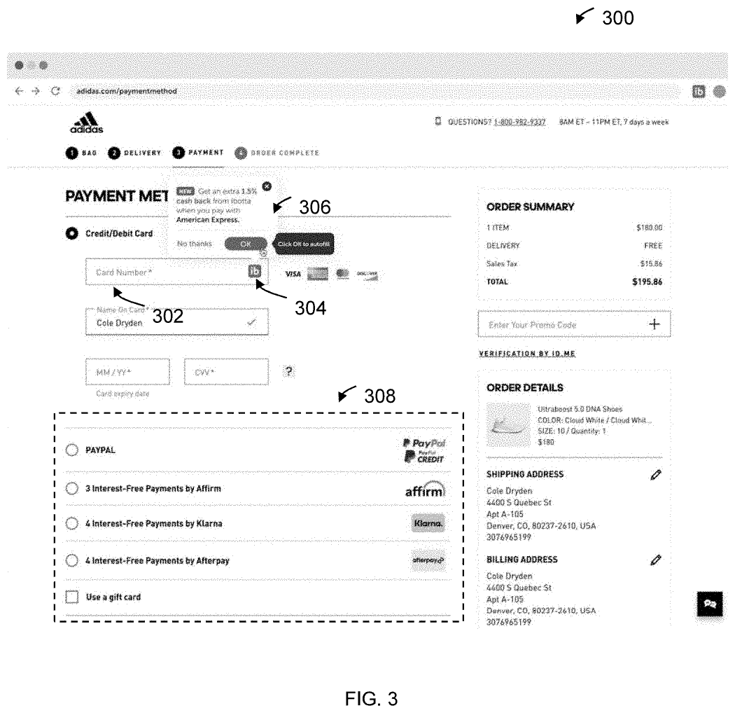

FIG. 3 is a graphical representation of an example user interface provided on the client node 102 of FIG. 1. In this embodiment, the user has one card (or, alternative payment methods) on file, and the card issuer (a financial institution such as a bank, alternatively, other payment facilitators) may have an active interactive data unit (e.g., reward) that the user qualifies for (based on user-demographic-based target criteria, transaction-based target criteria, or a combination thereof, as described in connection with FIG. 1). In this example, the client node 102 may be a desktop or laptop computer system, and the check-out web page and the interactive data units (e.g., rewards or incentives provided by financial institutions) are presented via a web browser window of the client node 102. The web browser window of the client node 102 provides a user access to the payment fields and the interactive data units, as well as facilitates user interactions with the payment fields and the interactive data units. In some embodiments, a browser extension to the web browser may be utilized to display various forms and/or related information of the interactive data units. The browser extension may scrape a retailer's check-out web page in real-time (or near real-time) to identify payment fields and transaction data and send the transaction data to the server platform (e.g., server platform 120) to identify relevant rewards. While a web browser window (and potentially the browser extension) is presented in FIG. 3, it will be appreciated that a mobile application may perform the same or substantially similar functionalities described elsewhere herein. As depicted in FIG. 3, payment fields 302 (in this case, credit card fields) may be presented in a form that indicates there is a reward or incentive available for this transaction (e.g., purchase) if one or more actions are performed per the interactive data unit, such as by placing an icon 304 (in this case, “ib” as shown in FIG. 3) in or near the payment fields 302. The icon 304 may be colored to present a graphically-distinct item so to draw the user's attention. Additionally, the system 100 may also display information associated with the interactive data unit, as shown by box 306 in FIG. 3, such as the text “get an extra 1.5% cash back from ‘provider’ when you pay with ‘financial institution A’” and allowing the user to interact (choose between “ok” or “no thanks”) with the interactive data units. In some cases, if the user chooses “ok” in box 306, the system 100 may autofill the card information on file for the user. Box 308 in FIG. 3 shows a number of alternative payment methods in the check-out web page. While the interactive data unit in FIG. 3 is injected into the user experience in connection with credit card payment, if there are rewards available associated with the alternative payment methods, the platforms and systems of the present disclosure may also inject the interactive data units into the alternative payment methods to facilitate user experience.

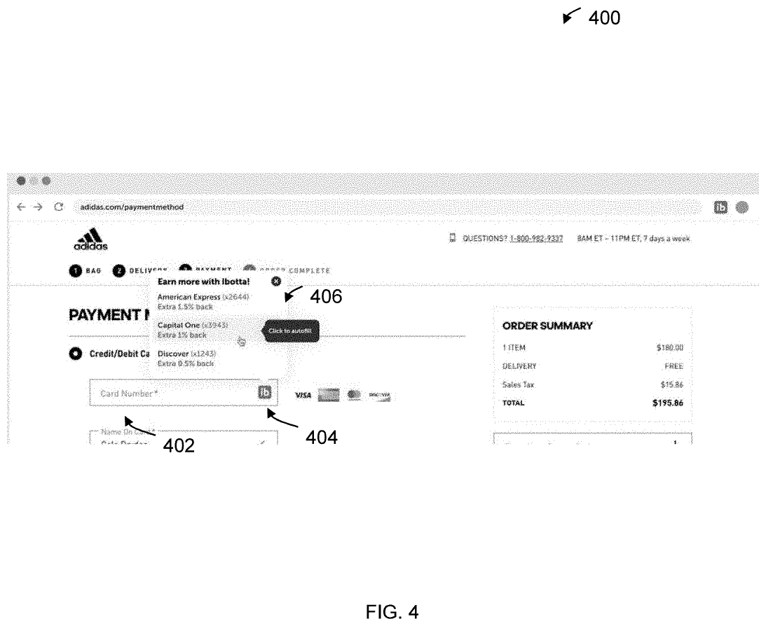

FIG. 4 is a graphical representation of an example user interface provided on the client node 102 of FIG. 1. In this embodiment, the user has multiple cards (or, alternative payment methods) on file, and the card issuers (financial institutions such as a banks, alternatively, other payment facilitators) may have active interactive data units that the user qualifies for (based on user-demographic-based target criteria, transaction-based target criteria, or a combination thereof, as described in connection with FIG. 1). As depicted in FIG. 4, payment fields 402 (in this case, credit card fields) may be presented in a form that indicates there is a reward or incentive available for this transaction (e.g., purchase) if one or more actions are performed per the interactive data unit, such as by placing an icon 404 (in this case, “ib” as shown in FIG. 4) in or near the payment fields 402. The icon 404 may be colored to present a graphically-distinct item so to draw the user's attention. In this embodiment shown in FIG. 4, the user has multiple cards on file, and the card issuers provide interactive data units (e.g., rewards) that the server platform determines that the user qualifies for, thus multiple rewards are displayed in box 406. For example, these rewards may be presented, as shown in FIG. 4, by the text “American Express (x2644) extra 1.5% back”, “Capital One (x3943) extra 1% back”, and “Discovery (x1243) extra 0.5% back”. The user may interact with these interactive data units by choosing (clicking) the one he or she determines to use to complete this transaction. By clicking one of the payment methods (one of the cards), the system 100 may autofill the card information on file associated with the chosen card for the user.

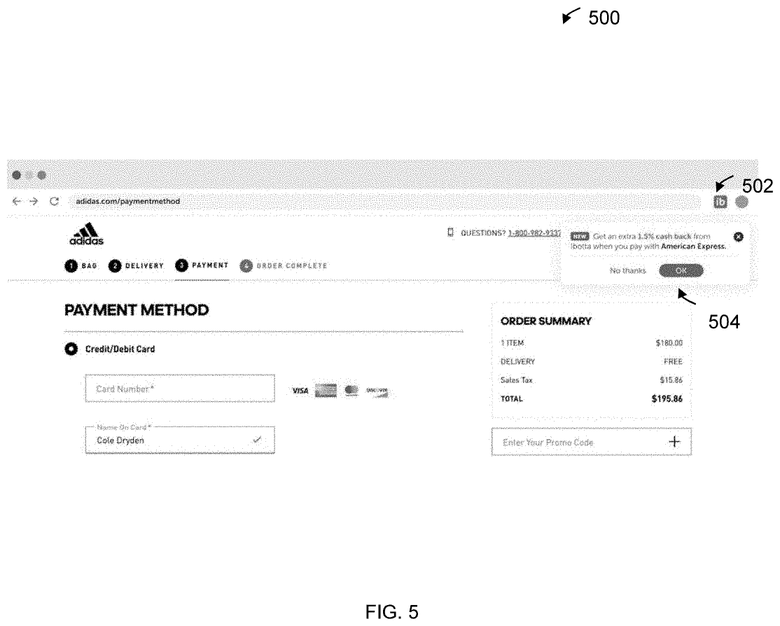

FIG. 5 is a graphical representation of an example user interface provided on the client node 102 of FIG. 1. Beneficially, the platforms or systems of the present disclosure may still deliver interactive data units to the user experience even when a page scrape is not successful. In this embodiment, the platforms or systems of the present disclosure may not be able to detect the payment method field (e.g., credit card field) in the check-out web page. In this case, the browser extension of the client node may actively inject the interactive data unit in a web browser extension panel. As depicted in FIG. 5, an icon 502 (in this case, “ib” as shown in FIG. 5) may be injected to the web browser extension panel to indicate there is an available reward for this potential transaction (e.g., purchase) if one or more actions are performed, per one or more interactive data units. The icon 502 may be colored to present a graphically-distinct item so to draw the user's attention. In this embodiment shown in FIG. 5, the reward may be presented in a notification box 504, such as “get an extra 1.5% cash back from ‘provider’ when you pay with ‘financial institution A’”. While FIG. 5 shows a check-out web page of a retailer, the display of the rewards by the browser extension panel may be presented in any web page of a retailer, such as in a shopping page, in a search page, etc. Therefore, the user may be informed of the available rewards at any time while visiting the website, or be notified by email before shopping. While a browser extension is presented in FIG. 5, it will be appreciated that a mobile application may perform the same or substantially similar functionalities described elsewhere herein.

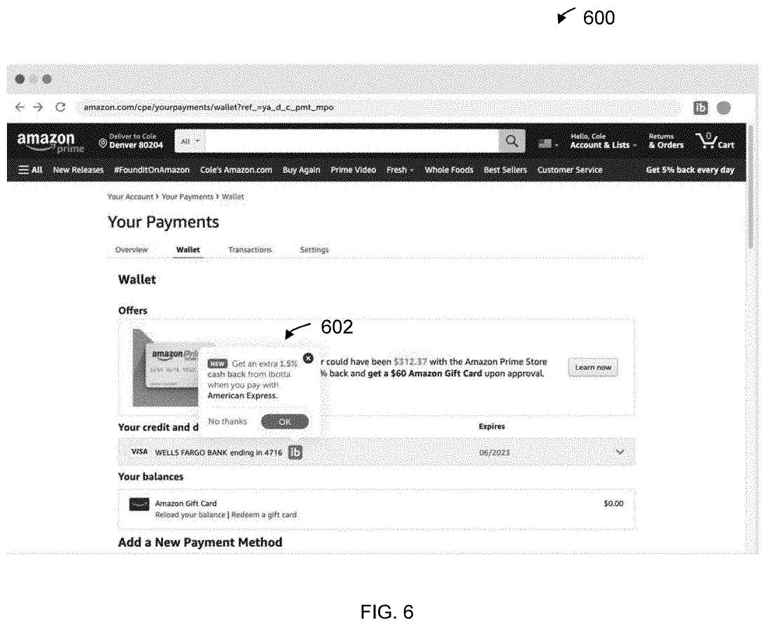

FIG. 6 is a graphical representation of an example user interface provided on the client node 102 of FIG. 1. In this embodiment, the user may have a default card (or alternative payment method) stored in a website, and generally use this default card to pay for any purchases. The platforms and systems of the present disclosure may determine that there is a reward associated with another payment method that the user qualifies for per one or more interactive data units, and may display the reward in box 602. Box 602 indicates that the user may “get an extra 1.5% cash back from ‘provider’ when you pay with ‘financial institution A’”. This may allow the user to switch to the rewarded payment method to complete the transaction.

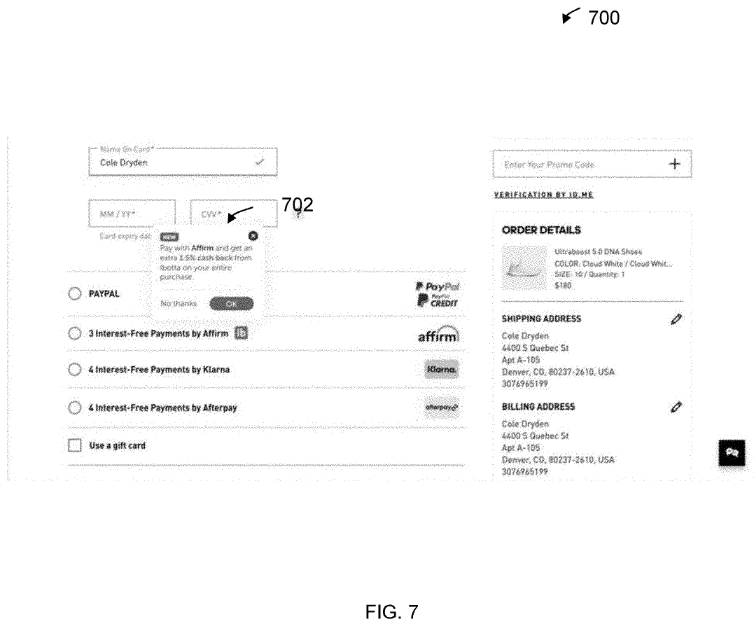

FIG. 7 is a graphical representation of an example user interface provided on the client node 102 of FIG. 1. In this embodiment, the user has an alternative payment method on file, and the payment method issuer (in this case, Affirm) has an active interactive data unit that the user qualifies for with this potential transaction (based on user-demographic-based target criteria, transaction-based target criteria, or a combination thereof, as described in connection with FIG. 1). As depicted in FIG. 7, the alternative payment field may be presented in a form that indicates there is a reward or incentive available for this transaction (e.g., purchase) if the user uses this particular transaction method (e.g., payment method), such as placing an icon (in this case, “ib” as shown in FIG. 7) in or near the payment method option. The icon may be colored to present a graphically-distinct item so to draw the user's attention. Additionally, the system 100 may also display information associated with the interactive data unit, as shown by box 702 in FIG. 7, such as “pay with Affirm and get an extra 1.5% cash back from ‘provider’ on your entire purchase” and allow the user to interact (choose between “ok” or “no thanks”) with the interactive data units (e.g., rewards, incentive, etc.).

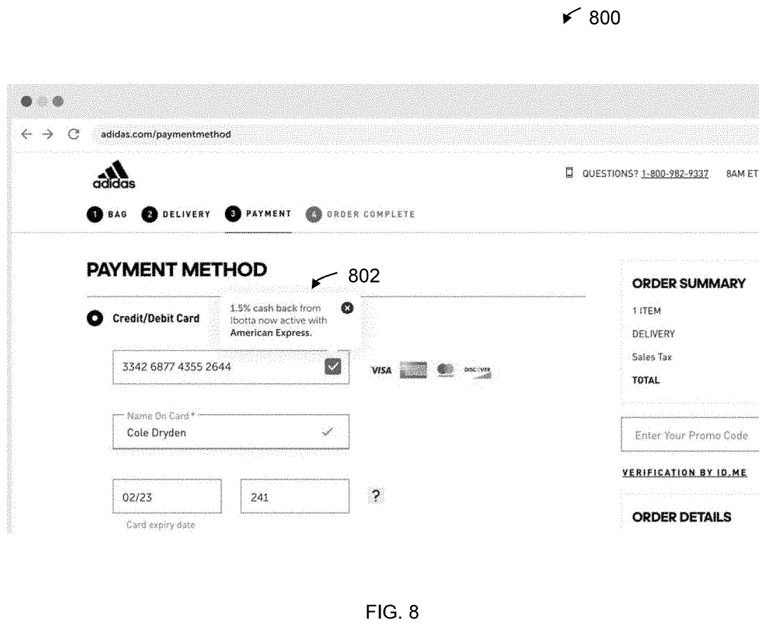

FIG. 8 is a graphical representation of an example user interface provided on the client node 102 of FIG. 1. In this embodiment, the user chose a rewarded payment method associated with an interactive data unit to complete the potential transaction. Beneficially, Box 802 may provide notification to the user that the cash back is in an active state once particular actions are performed, such as when the correct card information has been entered (manually or by autofill). For example, as shown in FIG. 8, Box 802 may display the text “1.5% cash back from ‘provider’ now active with American Express”.

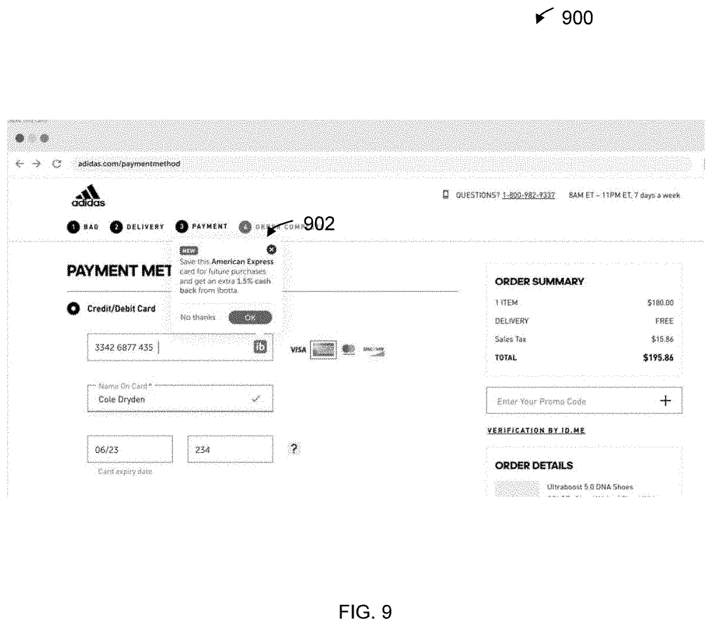

FIG. 9 is graphical representation of an example user interface provided on the client node 102 of FIG. 1. In this embodiment, the platforms or systems of the present disclosure may be used to incentivize a user to save a non-existing payment method information to the user profile of the user, such as by delivering an interactive data unit, which the user qualifies for, requiring this action to the user experience. For example, Box 902 may notify the user that if the user performs an action, such as to save this credit card to the user profile, then the user may get a cash back for this purchase. The platforms or systems of the present disclosure may detect the input of a credit card number, and may determine, based on the first several numbers of the input, that this is a new card which is not on file with the user yet. Then the server platform 102 may, in real-time, present the notification in Box 902 to incentivize the user to store the card with the user profile. A storage system (e.g., database 150) may be utilized to store user profile information including the credit card information. Any credit card information may be stored in accordance with the Payment card industry (PCI) compliance standard in the storage system of the present disclosure.

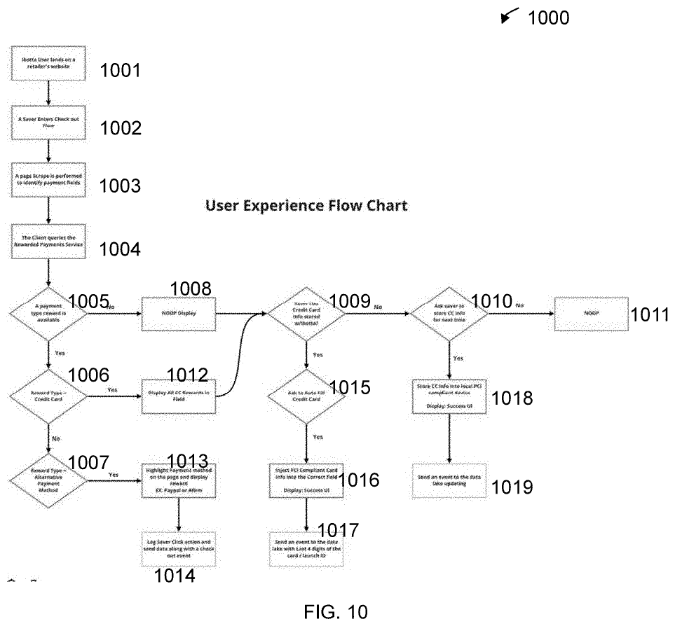

FIG. 10 is a flow diagram depicting an example process 1000 for delivering interactive data units, according to one exemplary embodiment. As depicted in FIG. 10, once the platforms and systems of the present disclosure are initialized, the process 1000 begins with operation 1001, wherein the system 100 detects that a user lands on a retailer's website (e.g., via a client node). Next, the process 1000 continues to operation 1002, wherein the system 100 detects that the user entered a check-out flow (e.g., the user is on a check-out page via a client node). In some cases, the client node may actively gather and update transaction data in real-time or near real-time in operations 1001 and/or 1002. Next, the process 1000 continues to operation 1003, wherein the system 100 performs a page scrape to identify a payment field on the check-out page. For example, the system 100 may scrape the check-out page for any possible payment field. In some embodiments, even when the system 100 cannot successfully scrape a payment field, it may still inject the interactive data units to the web page via web browser extensions or mobile applications, as described elsewhere herein such as in connection with FIG. 5. In the event the system 100 successfully scrapes the payment field on the check-out page, the process 1000 proceeds to operation 1004, wherein the client node may query the system for interactive data units. As described elsewhere herein, the server platform 120 of the system 100 maintains a database 150, which may store available rewarded payment offers (interactive data units which provide rewards or incentives if the user uses a selected payment method to complete a transaction). For example, the interactive data unit management module 128 and interactive data unit matching engine 124 may be utilized to identify the available interactive data units (e.g., comprising rewarded payment offers) for the user. Next, in operation 1005 of the process 1000, the system determines whether a rewarded payment method is available for the user (e.g., using the interactive data unit management module 128 and interactive data unit matching engine 124). If the system 100 determines there is no rewarded payment method available for the user in operation 1005, the process 1000 proceeds to operation 1008, wherein the system 100 may respond with an No Operation (NOOP) display, i.e., a command that is a placeholder and does nothing.

If the system 100 determines there is an available rewarded payment method for the user in operation 1005, the process 1000 proceeds to operation 1006, wherein the system 100 determines whether the rewarded payment method is associated with a credit card (versus alternative payment methods). If the system 100 determines that the available rewarded payment method for the user is not a ‘credit card’ type in operation 1006, process 1000 proceeds to operation 1007, wherein the system 100 determines that the rewarded payment method is an ‘alternative payment’ type. In some embodiments, having a ‘credit card’ type of rewarded payment method does not automatically conflict with having an ‘alternative payment’ type of rewarded payment method, and the system 100 may display both types of rewarded payment methods if the user qualifies for them. Next, if the system 100 determines there is an ‘alternative payment’ type of rewarded payment method available to the user in operation 1007, the process 1000 proceeds to operation 1013, wherein the system 100 may highlight the ‘alternative payment’ type of payment method on the page and display the reward. In some embodiments, the interactive data unit delivery engine 126 of the system 100 may perform the functionality of operation 1013. Next, the process 1000 proceeds to operation 1014, wherein the system 100 logs user click action and sends related data along with a check-out event to the server platform 120.

Referring back to operation 1006, if the system 100 determines the rewarded payment method is associated with a credit card, the process 1000 proceeds to operation 1012, wherein the system 100 may display all available credit card rewards in the payment fields (for example, see, FIG. 3 and FIG. 4, wherein FIG. 3 shows the scenario where one credit card reward is available to the user, and FIG. 4 shows the scenario where multiple credit card rewards are available to the user). Next, the process 1000 proceeds to operation 1009, wherein the system 100 determines whether the user has credit card information stored with the server platform 120. This operation 1009 may be performed by querying the database 150 in accordance with the PCI compliance standard. If the system 100 determines that the credit card information is stored with the server platform 120, the process 1000 may proceed to operation 1015, wherein the system displays an option for the user to autofill the credit card information to facilitate a convenient check-out user experience. If the user chooses to autofill the credit card information, the process 1000 may proceed to operation 1016, wherein the system 100 injects PCI compliant card information into the corresponding field(s), and display a “success” notification to notify the user that the credit card information has been entered successfully. Next, the process 1000 may proceed to operation 1017, wherein the system 100 may send an event (e.g., check-out completed) to the data lake (e.g., storage system/database 150) along with related information of the card (e.g., last four digits of the credit card) and/or launch ID.

Referring back to operation 1009, if the system 100 determines the user does not have credit card information stored with the server platform 120, the process 1000 may proceed to operation 1010, wherein the system 100 displays an option for the user to save credit card information so that the user may use it for the next purchase. If the user chooses to store the credit card information, the process 1000 may proceed to operation 1018, wherein the system 100 stores the credit card information into a local PCI compliant device, and display a “success” notification to notify the user that the credit card information has been stored successfully. In some embodiments, the system 100 may generate an interactive data unit (e.g., comprising a reward) to incentivize the user to store the credit card information with the system, as shown in FIG. 9. Next, the process 1000 may proceed to operation 1019, wherein the system 100 may send an event to the data lake (e.g., storage system/database 150) along with the credit card information to update one or more entries for the user profile. Referring back to operation 1010, if the user chooses not to store the credit card information, the process 1000 may proceed to operation 1011, wherein the system 100 may respond with an No Operation (NOOP) display, i.e., a command that is a placeholder and does nothing. While process 1000 includes multiple operations, it will be appreciated that not all these operations are required for the platforms and systems of the present disclosure, and several operations can be omitted.

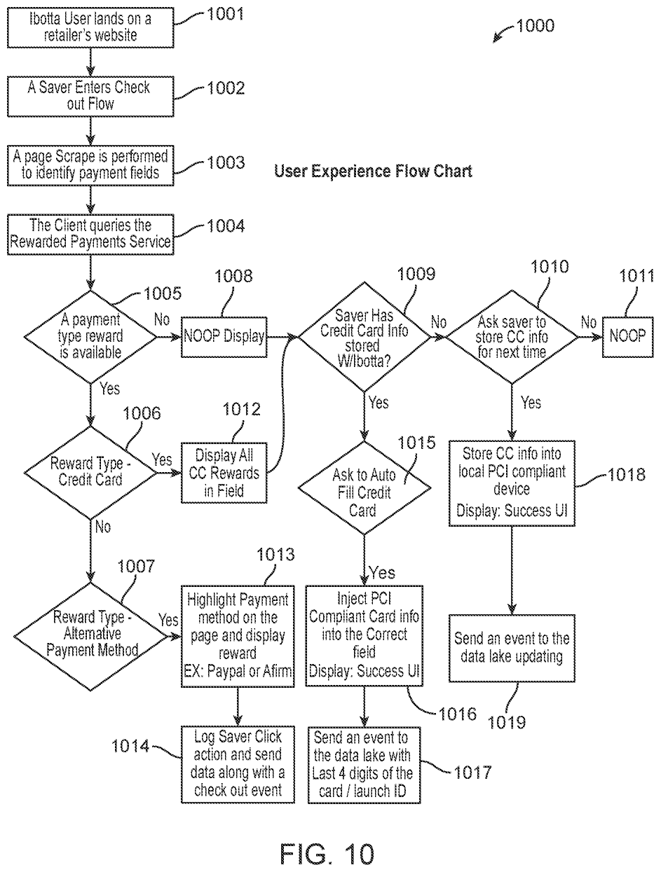

FIG. 11 is a block diagram depicting an example system 1100 for delivering interactive data units, focusing on the server side operations, according to one example embodiment. As depicted in FIG. 11, the system 1100 may query 1101 whether the user chooses to store a card with the platforms and systems of the present disclosure (e.g., server platform 120), when the user is on an online shopping website 1102 with a web browser extension. If the user chooses to store the credit card information with the server platform 120 in block 1101, the system 1100 will save the payment information (in accordance with the PCI compliance standard) on the client node for later auto fill purposes. The notification provided by block 1101 may be triggered by the event that a user is on an e-commerce website in block 1102, or it may be triggered by the event that a user is on a check-out page in block 1103. In block 1103, the event that a user is on a check-out page may trigger transmissions of data between client nodes and the interactive data unit omnibus engine 1104 (“Ibotta Ad Engine” in FIG. 11). For example, the client node may transmit transaction data associated with a potential transaction to the interactive data unit omnibus engine 1104. The transaction data associated with a potential transaction may include, without limitation, website URL, cart total or transaction amount, user ID, cart items or purchase categories, current known wallet, etc. Additionally or alternatively, the client node may receive information regarding the matched rewarded payment methods from the interactive data unit omnibus engine 1104 and display them to the user (e.g., bid winner: AMEX; reward: $2.00). The matching process is described in connection with the interactive data unit matching engine 124; the interactive data unit matching engine 124 may be a part of or a sub-component to the interactive data unit omnibus engine 1104. After the user receives the information regarding the matched rewarded payment methods on the client node, the user may choose to accept the reward (if only one is available) or choose one from multiple available rewards in block 1103. Either way, the payment selection event may be transmitted to interactive data unit omnibus engine 1104. The payment selection event may include information such as, without limitation, website URL, transaction amount of the purchase (which may be used to calculate the reward amount if it is percentage-based reward), user ID, timestamp associated with the transaction, etc.

During the process, when the interactive data unit omnibus engine 1104, by using a real-time decision matrix, determines the interactive data units to be presented to the user, a number of databases and interfaces may be utilized. For example, the interactive data unit omnibus engine 1104 may query the user information database 1105 for user demographic information. Database 1105 may communicate directly with financial institution information database 1107 (e.g., bank information) for information related to a user, such as credit scores, propensities of the user, last purchase of the user (which may provide insight as to user behavior), and interchange rates by site. Database 1105 may save these information received from financial institution information database 1107 to enrich the user profile information. Database 1105 may also communicate directly with internal database 1108 (e.g., “Ibotta information”) for information related to a user, such as purchase behavior, demographic information, and/or propensities, etc. These pieces of information may help a provider (e.g., of an interactive data unit) target a subset of the users based on demographics, device information, geographical location, site categories and brand safety, past purchases, or any other criteria. Database 1105 may also communicate directly with bidding interface 1109 to provide access to providers. Additionally, the bidding interface 1109 may also communicate directly with financial institution bid information database 1106 to provide access to the providers. In some cases, this bidding interface 1109 can perform the same or substantially similar functionality as interactive data unit provider interface 130 shown in FIG. 1. The providers (e.g., financial intuitions such as banks, credit card issuers, alternative payment method providers, mobile payment system providers, etc.) may establish a campaign, via the bidding interface 1109, to specify targeting criteria for an interactive data unit. For example, the targeting criteria may include, without limitation: a) specific site or site category (e.g., sport goods, or first aid retailers); b) transaction amount range (e.g., greater than $40 or less than $200); c) a reward type (e.g., percentage-based or fixed reward); d) a reward range for the bidding process; e) key demographic data; f) target credit score (e.g., a threshold or a range); g) past purchase behavior; h) share of wallet; i) user-segmentation-related information; j) first & third party audience segments; k) date/time ranges (e.g., associated with the transaction, or associated with the availability of the rewards); l) geographic targeting, etc. These criteria may be communicated, via the bidding interface 1109, and stored in the financial institution bid information database 1106. The interactive data unit omnibus engine 1104 may then query one or more of databases 1105, 1106, 1107, and 1108, directly or indirectly, for information related to the bidding decision making process, for example to determine which interactive data units are available to the user. As described elsewhere herein, the interactive data unit omnibus engine 1104 may receive the transaction data associated to the potential purchase, and thus may determine, based on the criteria set by the provider, the transaction data, and the user data, what interactive data units to present to the user.

Once the interactive data unit omnibus engine 1104 determines which rewards to present to the user, the user may receive a notification regarding the interactive data units on the check-out page, as shown in block 1111 (e.g., “earn $2.00 when you user your AMEX”). The user may also be presented with an option, for example, as shown in block 1110, whether to cash out the reward as statement credit. The system 1100 may provide multiple options for the user to obtain their reward associated with the interactive data units, such as direct cash payment from the server platform 120 directly via Automated Clearing House (ACH), gift cards etc. (e.g., direct credit to the user account maintained by the server platform 120), or through the statement credit via the providers (e.g., financial institutions, etc.).

When the user is on the check-out page as shown by block 1111, if the user completes a transaction, the client node may send a check-out event to the check-out events database 1112. The check-out event may be sent along with various data, such as website URL, transaction amount, timestamp, payment method information (e.g., first 6 digits of the credit card used for the payment, last 4 digits of the credit card used for the payment, etc.). A financial institution interface may allow the server platform 120 to verify the completion of the transaction. For example, the server platform 120 (or a sub-component of the server platform 120, such as interactive data unit omnibus engine 1104) may query a bank for recent transactions that are associated with identifiable information associated with the payment method (e.g., the last 4 digits of a credit card). To determine whether a user completed a transaction with a rewarded payment method, whether the user made a return, or whether the potential transaction was updated (e.g., adding more items to a potential transaction, combine existing purchases, or return a portion of the purchased items, etc.), the interactive data unit omnibus engine 1104 may communicate directly with check-out events database 1112. The interactive data unit omnibus engine 1104 may query and utilize information from the retailer, the providers, and/or the user simultaneously to make the determinations. If the system 1100 determines there are some changes to the purchase, it may reserve and/or revoke the reward associated with the transaction. In some embodiments, the rewards may automatically be put into a pending state based on the risk level of the transaction. The risk level of the transaction (e.g., the likelihood that the user will complete the transaction with the rewarded payment method and not to return or cancel) may be determined based on a number of factors, such as: a) transaction amount; b) timestamp; c) first 6 digits of the credit card; d) last 4 digits of the credit card; e) selection and completion of a transaction with a third-party payment method provider (e.g., Paypal®, Klarna®, etc.), and the like. Additionally or alternatively, the user behavior and/or past purchase information may also be used to determine a risk level of the transaction. Other data received from financial institutions, such as available fund with the user, debt default rate, credit scores, and the like, may also be used to determine a risk level of the transaction, in comparison to the transaction amount of the potential transaction. In any event, once it is determined that the user has completed the transaction with a rewarded payment method (and optionally that a transaction is final, e.g., return period has lapsed), the platforms and systems of the present disclosure may post the scheduled reward to the user's account, either through a statement of credit with the provider (e.g., Chase Bank, Citibank, etc.), or as a gift card or direct account credit to the user.

### Computer Systems

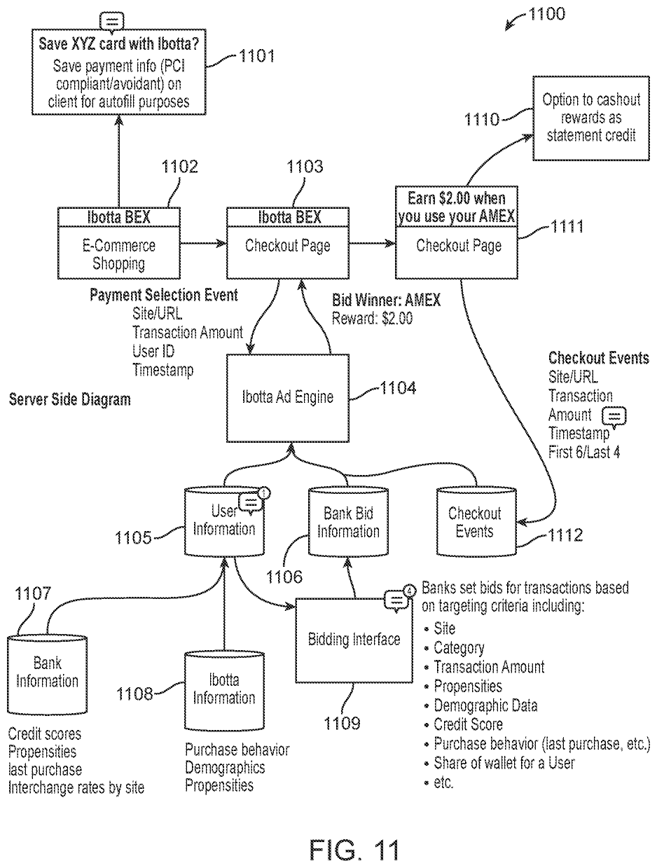

The present disclosure provides computer systems that are programmed to implement methods of the disclosure. FIG. 12 shows a computer system 1201 that is programmed or otherwise configured to deliver interactive data units. The computer system 1201 can be an electronic device of a user or a computer system that is remotely located with respect to the electronic device. The electronic device can be a mobile electronic device.

The computer system 1201 includes a central processing unit (CPU, also “processor” and “computer processor” herein) 1205, which can be a single core or multi core processor, or a plurality of processors for parallel processing. The computer system 1201 also includes memory or memory location 1210 (e.g., random-access memory, read-only memory, flash memory), electronic storage unit 1215 (e.g., hard disk), communication interface 1220 (e.g., network adapter) for communicating with one or more other systems, and peripheral devices 1225, such as cache, other memory, data storage and/or electronic display adapters. The memory 1210, storage unit 1215, interface 1220 and peripheral devices 1225 are in communication with the CPU 1205 through a communication bus (solid lines), such as a motherboard. The storage unit 1215 can be a data storage unit (or data repository) for storing data. The computer system 1201 can be operatively coupled to a computer network (“network”) 1230 with the aid of the communication interface 1220. The network 1230 can be the Internet, an internet and/or extranet, or an intranet and/or extranet that is in communication with the Internet. The network 1230 in some cases is a telecommunication and/or data network. The network 1230 can include one or more computer servers, which can enable distributed computing, such as cloud computing. The network 1230, in some cases with the aid of the computer system 1201, can implement a peer-to-peer network, which may enable devices coupled to the computer system 1201 to behave as a client or a server.

The CPU 1205 can execute a sequence of machine-readable instructions, which can be embodied in a program or software. The instructions may be stored in a memory location, such as the memory 1210. The instructions can be directed to the CPU 1205, which can subsequently program or otherwise configure the CPU 1205 to implement methods of the present disclosure. Examples of operations performed by the CPU 1205 can include fetch, decode, execute, and writeback.

The CPU 1205 can be part of a circuit, such as an integrated circuit. One or more other components of the system 1201 can be included in the circuit. In some cases, the circuit is an application specific integrated circuit (ASIC).

The storage unit 1215 can store files, such as drivers, libraries and saved programs. The storage unit 1215 can store user data, e.g., user preferences and user programs. The computer system 1201 in some cases can include one or more additional data storage units that are external to the computer system 1201, such as located on a remote server that is in communication with the computer system 1201 through an intranet or the Internet.

The computer system 1201 can communicate with one or more remote computer systems through the network 1230. For instance, the computer system 1201 can communicate with a remote computer system of a user (e.g., client nodes). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1201 via the network 1230.

Methods as described herein can be implemented by way of machine (e.g., computer processor) executable code stored on an electronic storage location of the computer system 1201, such as, for example, on the memory 1210 or electronic storage unit 1215. The machine executable or machine readable code can be provided in the form of software. During use, the code can be executed by the processor 1205. In some cases, the code can be retrieved from the storage unit 1215 and stored on the memory 1210 for ready access by the processor 1205. In some situations, the electronic storage unit 1215 can be precluded, and machine-executable instructions are stored on memory 1210.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1201 can include or be in communication with an electronic display 1235 that comprises a user interface (UI) 1240. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1205.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer-implemented method for providing real-time interactive data units in a user experience, comprising:
(a) retrieving, by one or more computer processors, transaction data associated with a potential transaction of a user;
(b) selecting, by one or more computer processors, one or more interactive data units from a plurality of interactive data units based at least in part on (i) the respective criteria associated with each interactive data unit of the plurality of interactive data units, and (ii) the transaction data associated with the potential transaction;
(c) presenting the one or more interactive data units to the user via a user device of the user;
(d) detecting, by one or more computer processors, a completion of the potential transaction via one of the one or more interactive data units; and
(e) altering an account of the user based on information associated with the one of the one or more interactive data unit via which the transaction was completed.

2. The method of claim 1, wherein (a)-(e) are performed by the one or more computer processors in real-time.

3. The method of claim 1, further comprising, prior to (a), receiving, by one or more computer processors, a user request to access a transaction page on a web page from the user device of the user.

4. The method of claim 1, wherein the transaction data comprises one or more of a web page URL, a transaction amount, a user ID, one or more items in a virtual cart, and wallet information.

5. The method of claim 1, wherein the respective criteria associated with each interactive data unit comprises transaction-specific criteria.

6. The method of claim 5, wherein the transaction-specific criterial comprises one or more of a web page category, a range of transaction amount, a date of the transaction, and a time of the transaction.

7. The method of claim 1, wherein the respective criteria associated with each interactive data unit comprises user-specific criteria.

8. The method of claim 7, wherein the user-specific criteria comprises one or more of target demographic data for eligible users, credit score threshold for eligible users, past purchase behaviors, and share of wallet.

9. The method of claim 1, wherein the respective criteria associated with each interactive data unit comprises reward-specific criteria.

10. The method of claim 9, wherein the reward-specific criteria comprises one or more of a reward type and a reward range.

11. The method of claim 1, further comprising, subsequent to (b), auctioning, by the one or more computer processors, a display opportunity of the one or more interactive data units on a web page for the potential transaction.
